(19) United States
(12) Patent Application Publication
(10) Pub. No.: US 2018/0115750 A1
(43) Pub. Date: Apr. 26, 2018

(54) IMAGE RECORDING METHOD FOR USE ACTIVITY OF TRANSPORT MEANS

(71) Applicant: Yueh-Han LI, Guanshan Township (TW)

(72) Inventor: Yueh-Han LI, Guanshan Township (TW)

(21) Appl. No.: 15/335,356

(22) Filed: Oct. 26, 2016

(51) Int. Cl. H04N 7/18; H04N 5/77

(52) U.S. Cl. CPC H04N 7/188; H04N 5/772; H04N 7/185

(57) ABSTRACT

The present invention provides an image recording method for a use activity of a transport means, which includes: detecting, over a wireless network, whether an image recording device is located in a spatial range of the use activity of the transport means, acquiring use state information of the transport means that is located in the spatial range of the use activity, and when it is determined that the transport means in the spatial range of the use activity is normally used by a user according to its usage, starting the image recording device located in the spatial range of the use activity, and accordingly capturing and recording images related to the use activity of the transport means.

### BACKGROUND OF THE INVENTION

### 1. Field of the Invention

The present invention relates to control technologies of an image recording device, and more particularly to an image recording method for a use activity of a transport means.

### 2. Description of the Related Art

The sponsoring organization or individual of an activity wishes to have the activity be recorded in detail and completely for any reason. To meet this requirement, personnel are designated to be in charge of image recording like photographing and video recording; however, a comprehensive and complete recording cannot be achieved due to the limited number of the designated personnel, and recording can only be done from the perspective of bystanders, which still needs to be improved.

### SUMMARY OF THE INVENTION

Therefore, the main object of the present invention is to provide an image recording method for a use activity of a transport means, in which a related image recording device located in a spatial range of the use activity is started under a certain condition, to capture and record images related to the use activity of the transport means.

To achieve the above object, the present invention provides an image recording method for a use activity of a transport means, which includes: detecting, over a wireless network, whether an image recording device is located in a spatial range of the use activity of the transport means, acquiring use state information of the transport means that is located in the spatial range of the use activity, and when it is determined that the transport means in the spatial range of the use activity is normally used by a user according to its usage, starting the image recording device located in the spatial range of the use activity, and accordingly capturing and recording images related to the use activity of the transport means.

Specifically, the image recording method for a use activity of a transport means includes the following steps:

a. directly or indirectly connecting, over a wireless network, an image recording device and a transport means used by a participant;

b. acquiring geographical positioning information of the image recording device or the transport means;

c. acquiring use information of the transport means or physiological information of the participant;

d. determining, according to the geographical positioning information acquired in Step b, whether the transport means is located in a preset spatial range of the use activity;

e. determining, according to the use information or physiological information acquired in Step c, whether the transport means is being used by the participant according to its own usage; and

f. when the determination result in both Step d and Step e is yes, starting the image recording device to capture and record images continuously or in batches.

The wireless network is a wireless local area network (LAN) or wireless personal area network constructed by NFC, ZigBee, ANT, Wifi, radio frequency, or other similar near field transmission devices.

The image recording device may be a camera module built in a mobile phone, which serves as a part of a mobile communication apparatus, and may also be a digital camera, which is independent of a mobile communication apparatus and is connected thereto.

The image recording device may be in a movable state, that is, moving with the participant, or may be located at a fixed position in the spatial range of the activity.

The geographical positioning information may be global positioning system (GPS) information, Internet Protocol address, signal strength, or other related information that can be used for identifying a geographical location.

The transport means may be a bicycle, and the use information is information that is sufficient to determine the traveling state of the bicycle, such as pedaling force, pedaling frequency, riding speed, traveling distance, or body shaking of the bicycle.

The physiological information includes heart rate, respiration rate, or blood pressure.

In addition, the image records acquired by the above method may be uploaded to a network device over the Internet, and preset additional information may be incorporated into the image records before or after the image records are uploaded.

### BRIEF DESCRIPTION OF THE DRAWINGS

None

### DETAILED DESCRIPTION OF THE PREFERRED EMBODIMENTS

A preferred embodiment of the present invention will now be described in detail by way of example only.

In an image recording method for a use activity of a transport means according to a preferred embodiment of the present invention, the use activity of the transport means refers to bicycling for a special purpose, that is, bicycling performed by a player (i.e., participant) using a bicycle (i.e., transport means) according to the normal usage, namely, riding of the bicycle in a range of the use activity on a specific road section or in a specific geographical region; and images during the actual activity are recorded from the perspective of the participants using image recording devices taken along with the plurality of participants, so as to acquire image records that are more complete and richer than those in the prior art.

Specifically, the image recording method for a use activity of a transport means includes the following steps:

a. Device Connection

A mobile phone that is built with an image recording device therein and is taken along with a player is connected to a bicycle ridden by the player over a short-distance wireless network. According to the short-distance transmission characteristics of the short-distance wireless network and the fact that the image recording device is generally taken along with the player, it can be deduced from the connection that the player and the bicycle of the player are close in space.

The wireless network is known in the prior art, which is generally a wireless LAN or wireless personal area network for signal transmission constructed by NFC, ZigBee, ANT, Wifi, radio frequency, or other similar near field transmission devices that are respectively disposed on the image recording device and the bicycle. In other words, any wireless network that is capable of connecting the image recording device taken along with the player and the bicycle to acquire a sensing result of the player and the bicycle in a certain range is applicable in the implementation of this step.

b. Geographical Positioning

Geographical positioning information of the image recording device or the bicycle is acquired, and the geographical positioning information may be GPS information, Internet Protocol address, signal strength, or other related information that can be used for identifying a geographical location. Also, because it is deduced in Step a that the image recording device and the bicycle are located in a space of a certain range, no matter whether the geographical positioning information comes from the image recording device or the bicycle, the geographical location is within a certain range.

c. Motion Information

Use information of the bicycle or physiological information of the player is acquired.

The use information refers to information related to the traveling state of the bicycle, such as pedaling force, pedaling frequency, riding speed, traveling distance, or body shaking of the bicycle in traveling.

The physiological information of the player refers to physiological state information of the player in motion, such as heart rate, blood pressure, or respiration rate.

d. Space Determination

The geographical positioning information acquired in Step b is compared with the information about the geographical location range of the bicycling activity, and it is determined whether the geographical locations of the bicycle and the player deduced from the geographical positioning information are in a spatial range of the bicycling activity.

e. Motion Determination

It is determined whether the bicycle is in a traveling state of being ridden by the player according to the traveling information or physiological information acquired in Step c.

f. Image Capturing and Recording

When the determination result in both Step d and Step e is yes, the image recording device is started to capture and record images such as pictures, videos, or sound continuously or in batches.

g. Uploading

The image records acquired in Step f are uploaded to a network device over the Internet, and are published to social network sites or other specified network spaces. Additional information such as the title, sponsor, or slogan of the bicycling activity may be incorporated into the image records according to the actual requirements before or after the image records are uploaded.

The image records acquired by the above method come from images captured by participants from their perspective in the activity, and are closer to the actual activity state without modification as compared with the prior art, thereby truly and comprehensively recording and storing states at different locations in the whole activity. In addition, the image recording method for a use activity of a transport means is performed through a program, and thus the intensity and range of image capturing and recording can be further controlled or changed.

What is claimed is:

1. An image recording method for a use activity of a transport means, comprising the following steps:
a. directly or indirectly connecting, over a wireless network, an image recording device and a transport means used by a participant;
b. acquiring geographical positioning information of the image recording device or the transport means;
c. acquiring use information of the transport means or physiological information of the participant;
d. determining, according to the geographical positioning information acquired in Step b, whether the transport means is located in a preset spatial range of the use activity;
e. determining, according to the use information or physiological information acquired in Step c, whether the transport means is being used by the participant according to its own usage; and
f. when the determination result in both Step d and Step e is yes, starting the image recording device to capture and record images continuously or in batches.

2. The image recording method for a use activity of a transport means according to claim 1, wherein the wireless network is a wireless personal area network or wireless local area network (LAN).

3. The image recording method for a use activity of a transport means according to claim 1, wherein the image recording device serves as a part of a mobile communication apparatus, or is independent of a mobile communication apparatus and is connected thereto.

4. The image recording method for a use activity of a transport means according to claim 1, wherein the image recording device moves with the participant, or is located at a fixed position in the spatial range of the activity.

5. The image recording method for a use activity of a transport means according to claim 1, wherein the geographical positioning information is global positioning system (GPS) information, Internet Protocol address, or signal strength.

6. The image recording method for a use activity of a transport means according to claim 1, wherein the transport means is a bicycle, and the use information comprises pedaling force, pedaling frequency, riding speed, traveling distance, or body shaking of the bicycle.

7. The image recording method for a use activity of a transport means according to claim 1, wherein the physiological information comprises heart rate, respiration rate, or blood pressure.

8. The image recording method for a use activity of a transport means according to claim 1, further comprising the step of:
g. uploading the image records to a network device over the Internet.

9. The image recording method for a use activity of a transport means according to claim 8, further comprising the step of:
g′. incorporating additional information into the image records in Step f.

10. The image recording method for a use activity of a transport means according to claim 9, wherein Step
g′ is performed before or after Step g.
